(19) United States
(12) Patent Application Publication
(10) Pub. No.: US 2005/0160789 A1
(43) Pub. Date: Jul. 28, 2005

(54) Method, device and system for coding, processing and decoding odor information

(76) Inventors: Andreas Freyer, Dortmund (DE); Andree Ross, Lunen (DE); Wolfgang Theimer, Bochum (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/504,382

(22) PCT Filed: Feb. 22, 2002
(86) PCT No.: PCT/IB02/00530

(51) Int. Cl. G01N 7/00

(52) U.S. Cl. 73/23.34; 422/85

(57) ABSTRACT

An odor analysis must be made before any device is capable of synthesizing an odor. Generally, odor analysis must result in an abstract device-independent odor representation that can easily be processed by various devices. Of course, this representation has to be detailed enough to be the basis for a synthesis of an odor by chemical or mechanical processes. The present invention provides a method for coding, processing (e.g. modifying/adapting) and decoding odor. The method according to the invention allows coding a representation of an odor in a digital form or odor information, respectively. This odor information can fulfil the demand of an abstract device-independent odor representation whereas the odor information shows a form adequate for communicating odor information even over a wireless communication network. According to further aspects of the invention, a device for sensing, coding and communicating odor and a device for receiving, decoding and generating odor is provided.

The present invention relates to a method, a device and a system for coding and decoding of odor information. Particularly, the present invention relates to a method, a device and a system for efficiently coding odor information comprising a large number of individual odor representing values, for processing (e.g. adapting, modifying or manipulating) odor information in an adequate way, respectively, and for decoding

The spread of mobile devices, particularly mobile phone has dramatically increased over the last years. In high industrialized countries the total number of mobile phones increased to an overall coverage of over 80%. of the respective population of these countries. Additionally, the functionality of the mobile devices and mobile phones increased simultaneously offering for example communicational, entertaining and educational capabilities. Today such capabilities are often distributed among several specialized mobile devices. But it is apparent that forthcoming mobile devices will cover a plurality of different functional capabilities in the way, of complex integrated mobile devices. Such complex integrated mobile devices may offer voice communication, data transfer and, in view of the fact that forthcoming mobile communication networks provide high data rates, multi-media data transfer and playback.

The sensational experience of human beings in a certain environment is based on all human senses and passes on a true and complete perception of the situation. Modern communication devices address in the first place the human senses of seeing and hearing involving multi-media features like audio and video playback. Also the human sense of touch for example by including tactile feedback may be addressed. But up to now the human sense of odor and tasting is neglected to a large extend although especially the odor sensation may offer in combination with video presentation an overwhelming complete live impression of a certain presented ambience

The present invention will address a method, device and system allowing to offer odor sensation and perception in the environment of mobile terminal devices.

A number of patent documents relate to odor sensing, emitting and odor data transmitting, respectively.

WO 01/86986 A1 provides a method for retrieving and storing ciphered multi-media data in a digital mobile phone and a digital mobile phone therefor. The multi-media data is stored in a non-volatile detachable built-in memory and is decoded by means of adapted specialized multi-media decoder, like an image decoder, a voice decoder and the like. Further, the multi-media data is preferably downloaded for a network, particularly for the Internet. The patent application relates only to a general decoding of the multi-media data comprised within a described overall multi-media data structure and does not relate to the process of coding, adapting and decoding of the multi-media data, especially odor information, itself.

EP 1 046 910 A2 provides a preferably palm-sized apparatus, especially a cellular mobile phone, which is equipped with a functional unit able to measure gaseous components. The presented apparatus allows to analyze gaseous components and presents the analysis thereof to a user on a display of the apparatus. Again, the apparatus and the corresponding method do not address the coding of measured gaseous data involving for example the obtaining of an implementation of independent representation of the gaseous data, the adapting and the decoding thereof

U.S. Pat. No. 6,239,857 provides a process and a device for synchronously adding odors to visual and/or acoustic stimulation. The process and the device relates preferably to the generation of simultaneous odor impressions in combination with cinema, theater, concert, slide show, video and lecture events. Adapted and adequate pre-prepared odor information is suitable synchronously provided therefor. In particular, the process and the device are related to functionality and construction of an adequate odor exposing device offering a realistic perception thereof.

An object of the present invention is to provide a method for coding and decoding odor information, especially in view of communicating odor information between a transmitting odor sensing unit and a receiving odor emitting unit. Moreover, the communication is preferably performed employing wireless communication networks and the coding of the odor information takes the relative narrow bandwidth of wireless communication networks for data transmission and the relative cost-intensive communication of large amounts of data via wireless communication networks into consideration.

Further objects of the present invention are to provide a corresponding device and a corresponding system allowing to code and/or decode odor information according to the above described method.

The object of the present invention is solved by the accompanying independent claims.

According to one aspect of the invention a method for coding, processing (e.g. adapting/modifying) and decoding of odor is provided. The method comprises the operative steps of coding an odor information, processing the coded odor information and decoding the processed odor information. The odor information codes a data representation of an odor sensed by means of an odor sensing device. The odor information comprises at least an odor type and a corresponding strength or intensity of this odor type. The odor type may be a certain chemical compound, a designation of a class of chemical compounds or a designation of an aroma. The odor intensity may be a weighting value, an amount value or a similar value related to the strength of the corresponding odor type. The odor intensity may be normalized. The processing of this coded odor information may comprise any kind of data processing known in the art, i.e. adapting according to a predetermined adapting rule, modifying according to a predetermined modification or changing rule, or the odor data, e.g. strength or intensity or type may be processed in accordance to an adapting instruction such as a mathematical relationship, optionally before or after being represented in a certain matrix or vector representation. Such mathematical relationship may comprise a normalization and/or modification of the originally obtained or the coded odor information with respect to available odors when reproducing or generating the odor at a remote location. The decoding of the odor information may allow to obtain values or signals necessary to control an odor generating device or odor emitting device having a limited number of basic odor aromas or substances.

The coding and processing may be carried out in different locations by separate devices, but may also be carried out either at the same location, or by the same device or simultaneously. The coding may be done upon processing, and the processing may be done upon coding.

According to an embodiment of the method of the invention, the method comprises an operational step of sensing odor by the means of an odor sensing device.

According to an embodiment of the method of the invention, the method comprises an operational step of analyzing said odor information, especially analyzing the sensor values obtained from an odor sensing device.

According to an embodiment of the method of the invention, the method comprises an operational step of analyzing said odor information, in order to obtain an odor information based on a plurality of basic odor aromas. The plurality of basic odor aromas may be chosen such that some odors may be represented by a combination of basic odor aromas or a selection thereof. The combination may be based on weighting values related to different amounts of the basic odor aromas in order to define a representation of an odor. This kind of analysis of an odor may lead to a device-independent coding of odor.

According to an embodiment of the method of the invention, the method comprises an operational step of analyzing said odor information based on an analysis comprising relevant ingredients. An analysis of relevant ingredients may be based on a molecular or chemical compound analysis. Relevant ingredients may be molecules, chemical compounds or classes of chemical compounds contributing to the sensed odor. The representation of the odor may be dependent on the number of relevant ingredients taken into consideration.

According to an embodiment of the method of the invention, the method comprises an operational step of coding said odor information based on a plurality of basic odor aromas. This kind of coding of an odor may lead to a device-independent coding of odor.

According to an embodiment of the method of the invention, the method comprises an operational step of coding said odor information based on a coding comprising relevant ingredients. Preferably, the coding may be a subsequent coding of the relevant ingredients.

According to an embodiment of the method of the invention, the method composes an operational step of receiving odor information from the odor sensing device. The receiving may be operated in connection with a wired connection or a wireless connection.

According to an embodiment of the method of the invention, the operational step of processing, e.g. adapting may further comprise an operational step of adapting odor information in accordance with at least one threshold value. This adaptation may be employed to limit the strength or intensity of an odor coded in the odor information. Therefore, at least one threshold value may be defined.

According to an embodiment of the method of the invention, the operational step of processing e.g. adapting or modifying may further comprise an operational step of replacing parts of the odor information in accordance with a replacing rule. The replacing may be employed e.g. to eliminate parts of the odor information comprising the representation of unwanted or bad smelling odor. The pre-defined replacing rule may comprise the corresponding instructions for operating the replacing operation.

According to an embodiment of the method of the invention, the operational step of processing may further comprise an operational step of mapping the odor information in accordance with a mapping rule. The mapping may be employed e.g. to convert a coding based on a plurality of basic odor aromas into a coding based on a different plurality of basic odor aromas. The pre-defined mapping rule may comprise corresponding instructions for operating the mapping operation.

According to an embodiment of the method of the invention, the method comprises an operational step of storing odor information.

According to an embodiment of the method of the invention, the method comprises an operational step of transmitting odor information to the odor emitting device. The transmitting may be operated in connection with a wired connection or a wireless connection.

According to an embodiment of the method of the invention, the method comprises an operational step of generating odor by means of an odor emitting device.

According to an embodiment of the method of the invention, the operational step of generating may further comprise an operational step of adapting the odor information. The adaptation may be necessary to adapt the odor information to characteristics and properties of the odor emitting device. An adequate corresponding adapting rule may be pre-defined.

According to an embodiment of the method of the invention, the odor information may be received and/or transmitted via a wireless communication network.

According to a further aspect of the invention, a software tool for adapting odor information is provided. The software tool comprises program portions for carrying out the operations of the aforementioned method for adapting odor information when the software tool is implemented in a computer program and/or executed on a computer, a processing device or a mobile terminal.

According to a further aspect of the invention, a computer program for adapting odor information is provided. The computer program comprises program portions for carrying out the operations of the aforementioned methods for adapting odor information when the software tool is implemented in a computer program and/or executed on a computer, a processing device or a mobile terminal.

According to a further aspect of the invention, a computer program product for adapting odor information is provided which comprises program code portions stored on a computer readable medium for carrying out the aforementioned methods for adapting odor information when said program product is executed on a computer, a processing device or a mobile terminal.

According to a further aspect of the invention, a device for sensing, coding and communicating odor is provided. The device comprise an odor sensing unit, an odor coding unit and a transmitter. The odor sensing unit senses an odor and in connection with the odor coding unit the sensed odor is coded in an odor information in order to obtain a data representation of the odor. This odor information is transmitted by the transmitter of the device. The device may comprise a storage in order to store an odor information. Preferably, the device for sensing, coding and communicating odor information may be a mobile device or a portable device.

The odor coding unit may provide the capability to operate the operational steps of coding and processing described in connection with the aforementioned method. The odor coding unit may further comprise the possibility to analyze and/or adapt odor information. Again, The odor coding unit may provide the capability to operate the operational steps of adapting.

According to a further aspect of the invention, a device for receiving, decoding and generating odor is provided. The device comprises a receiver, an odor decoding unit and an odor emitting unit The receiver receives an odor information comprising a data representation of an odor. The odor information is supplied to the decoding unit and the resulting decoded odor information is employed to instruct and control the odor emitting unit to generate an odor equal or similar to the decoded representation of the odor. The device may comprise a storage in order to store an odor information. Preferably, the device for receiving, decoding and generating odor may be a mobile device or a portable device.

The odor coding unit may provide the capability to operate the operational steps of coding and processing described in connection with the aforementioned method. The odor coding unit may further comprise the possibility to analyze and/or adapt odor information. Again. The odor coding unit may provide the capability to operate the operational steps of adapting.

According to a further aspect of the invention, a system for communicating odor information is provided. The system comprises a device for sensing, coding and communicating odor, a transmitting means for transmitting said odor information and a device for communicating, decoding and generating odor. The device for sensing coding and communicating odor and the device for receiving/communicating, decoding and generating odor are described above.

The transmitting means may send, process and optionally receive the odor information previously coded by the corresponding device.

According to an embodiment of the method of the invention, the system further comprises a processing means for processing, e.g. adapting or changing odor information. The processing means may provide the capability to operate the operational steps of processing, adapting or modifying described in connection with the aforementioned method and may be comprised in the aforementioned transmitting means.

The invention will now be described referring to the drawings in which like references numbers represent corresponding parts throughout.

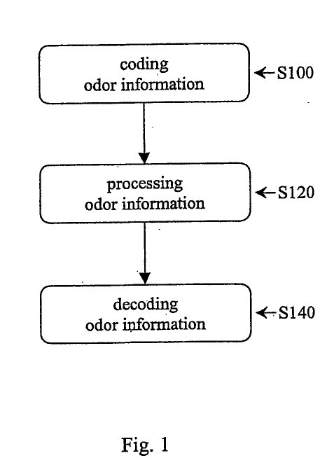

FIG. 1 shows an operational sequence of steps according to an embodiment of the method of the present invention,

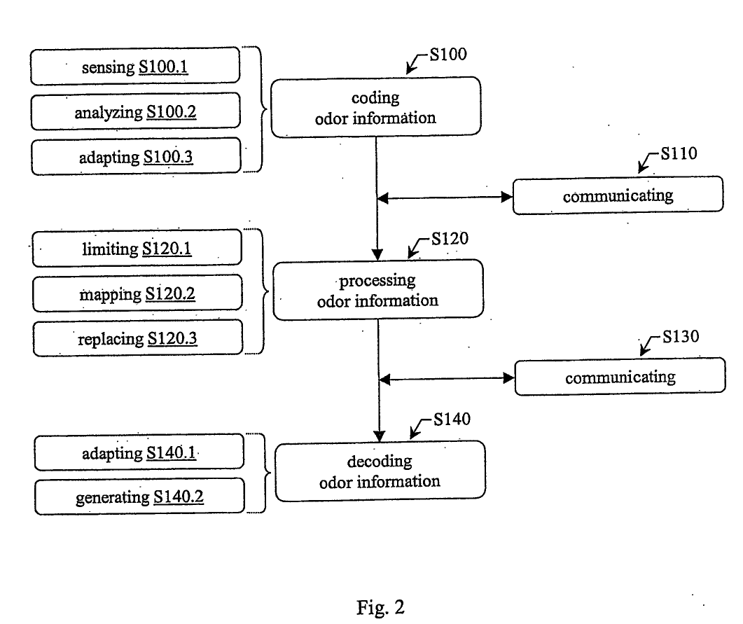

FIG. 2 shows an operational sequence of steps in more detail according to a further embodiment of the method of the present invention,

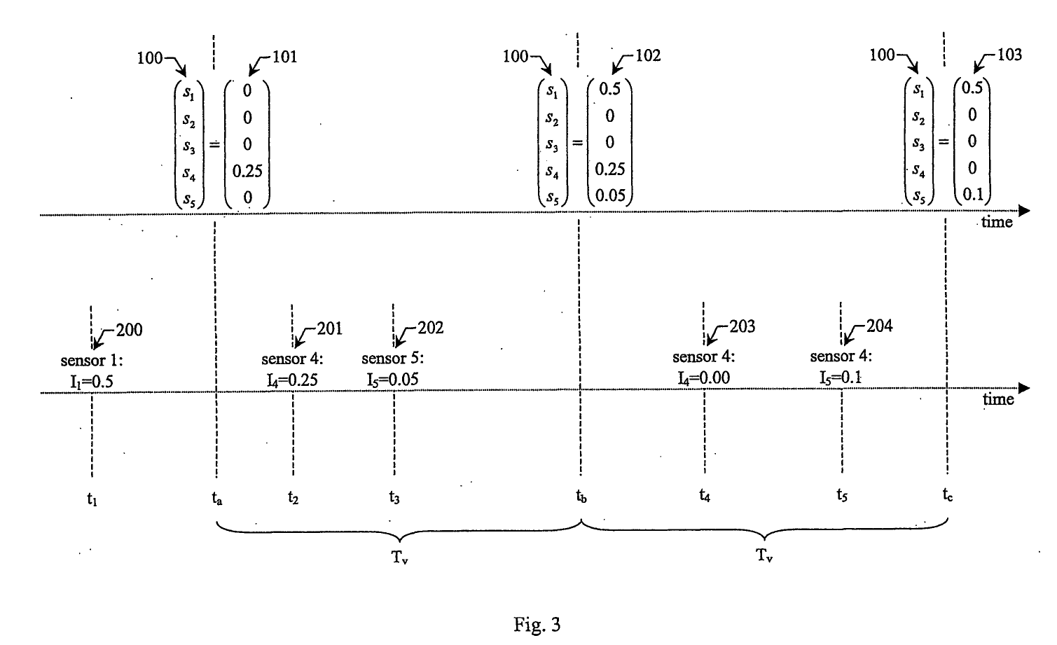

FIG. 3 shows two possible coding sequences of odor information with respect to the present invention,

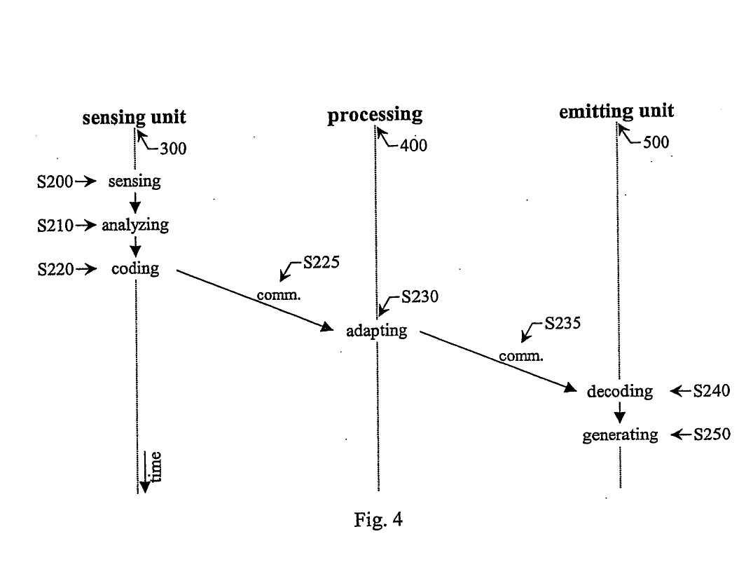

FIG. 4 illustrates a timely sequence of the odor information processing with respect to an embodiment the invention,

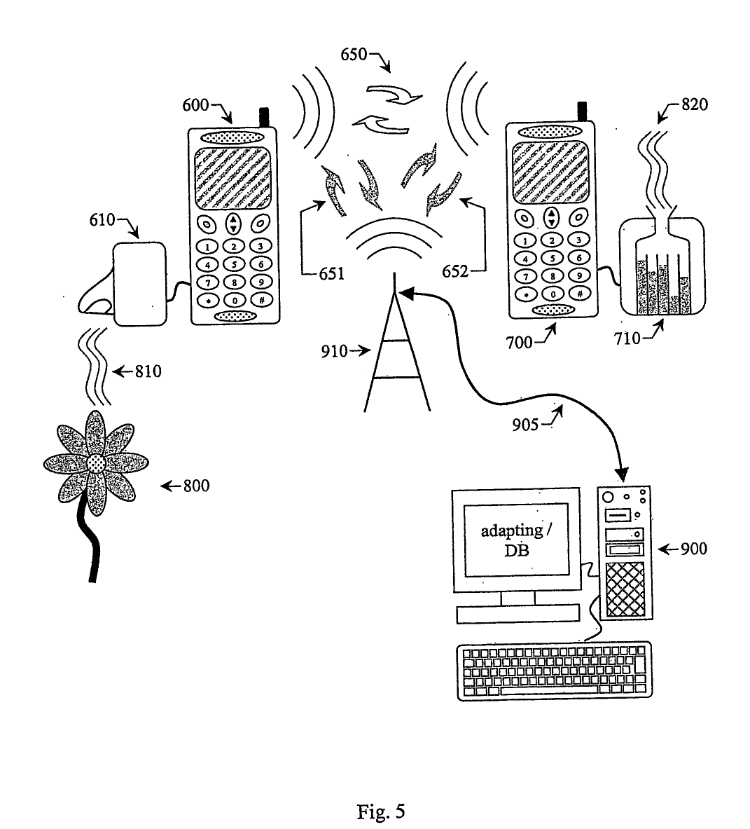

FIG. 5 illustrates an arrangement of communicating mobile devices according an embodiment of the system of the present invention.

In the following description of the exemplary embodiments, reference is made to the accompanying drawings which form part thereof, and in which is shown a way of illustrating the specific embodiments in which the invention may be practiced. It is to be understood that other embodiments may be utilized as structural changes may be made without departing from the scope of the present invention.

FIG. 1 shows an operational sequence of steps according to an embodiment of the method of the present invention. The FIG. 1 presents an overview of the embodiment of the method for coding, adapting and decoding odor information. Several detailed description of the single operational steps will be described as indicated above in the following figures.

It may be assumed that an odor sensing unit or an odor sensing device provides odor information, respectively. The structure and content of the sensed odor information may be based on the employed physical or chemical sensing and measuring method.

In a step S100, the sensed odor information is coded. The coding of the odor information may be performed with regard to a following communication of the odor information and/or with regard to a following adaptation of the odor information.

The general perception of odor sensed by a human being comprises in the first place an interaction of a plurality of chemical compounds interacting with distinct specialized human receptors. The number of specialized human receptors involved in the recognition of odor by a human is very large such that the electronic sensing of an odor and the subsequent generation of an odor based on a selection of aromas is difficult if the sensed odor and the odor sensation caused by the generated odor shall match or at least compare.

Preferably, an analysis of an odor may result in an abstract, odor representation. The representation should allow to be processed by various devices, wherein a device-independent odor representation may be advantageous. Thus, the sensing of odor, preferably by an electronic odor sensor, provides a large number of individual measurement values relating to e.g. the kind of chemical compounds and to a kind of odor strength or compound concentration, respectively.

The sensing of odor may be based on a sensory array, wherein each array element of the sensory array is dedicated to a specific chemical compound or a class of chemical compounds and senses an intensity value or a concentration value of this specific chemical compound. Such a sensory array specialized for sensing chemical compounds contributing to the odor sensation may be termed as electronic nose.

Further, a spectral analysis may be performed to identify the chemical compounds and their concentration contributing to the odor sensation. Chemical compounds may be identified by the means of a spectral analysis on the basis of spectrally active parts of the chemical compounds.

According to the above described idea of a device-independent odor representation and in view of a following generation of a similar odor by an odor emitting unit or an odor emitting device, respectively, it may be advantageous to analyze and code the sensed odor based on a plurality of basic aromas also termed as categories. This kind of odor processing may lead to a set of data representing the odor.

With regard to a communicating of the sensed and analyzed odor the resulting odor information may comprise a plurality of measured odor intensity values assigned to a certain chemical compound or category. Due to the amount of data included in the odor information an adapted and preferably packed coding for transferring the odor information may have to be chosen, especially sparse and redundant information may should be avoided.

The step S100 results in a representation of an odor sensation coded electronically for subsequent adaptation and for decoding in order to generate an odor of equal or similar odor sensation. The representation of an odor coded electronically may be termed in the following as odor information. The odor information comprises at least one odor type and a corresponding strength. Normally, odor information may comprise several odor types and corresponding strengths in order to subsequently enable a generation of an odor of similar, or equal odor sensation by an odor emitting unit or odor emitting device.

In a further step 120, the electronically coded odor information may be adapted. The processing may comprise a selective modifying of the odor strength, a replacing of parts of the odor information resulting in the replacing of for example unwanted odor composites and a mapping of odor information for example to adapt the odor information to the properties of a certain odor emitting unit or odor emitting device, respectively.

The odor sensation can have several levels of strength. The strength of odor sensation may vary within a range from barely noticeable over clearly noticeable and strong noticeable to an unbearable odor sensation. Therefor, it may be advisable to provide a modification of the odor strength. The odor strengths may be modified by scaling or by limiting odor strengths with respect to threshold values.

The sensory effect of odor may differ from human to human. An odor may smell really good to a human whereas the same odor may smell really bad to another one. Different odor sensations invoke different positive or negative associations. Therefore, it may be advisable to provide a replacement or deletion of a corresponding odor information or a part thereof. The replacing may comprise a total blocking of certain odor information of certain parts within the odor information.

The mapping of odor information in accordance with a corresponding mapping rule may comprise the above described modifying, replacing and/or blocking. A mapping operation may allow additionally to map an odor based on a selection of basic aromas to an odor based on an new and different selection of basic aromas.

In a further step 140, the odor information may be decoded. The decoded odor information may be supplied to an odor emitting unit or device, respectively. The decoding of the odor information may comprise a mapping of the odor information into a representation which may be interpreted properly by an odor emitting unit. The mapping may be preformed analog to an adapting operation described above with reference to step S120.

The odor emitting unit may generate an odor by mixing different basic aromas. The aromas may have to be physically or chemically treated before or during the mixing process. Such treatment information may be obtained by decoding odor information.

FIG. 2 shows an operational sequence of steps in more detail according to a further embodiment of the method of the present invention. The operational sequence of FIG. 2 describes the operational sequence presented in FIG. 1 in more detail.

Each operational steps S100, S120 and S140 shown in FIG. 1 may be divided into several sub-steps. The operations assigned to each sub-step were introduced in FIG. 1 and the corresponding description of FIG. 1. A detailed description to the single sub-steps follows below.

In a sub-step S100.1 an odor is sensed. As described above, an odor may be sensed by the means of a dedicated odor sensory array or by the means of a spectral analyzer.

Sensory arrays are often based on a physical adsorption of the chemical compounds on a particular prepared surface. Preferably, a physical quantity is changed in dependence to the amount of adsorbed chemical compounds such that the change in the physical quantity which is detected is related to the concentration and therefor also to the odor intensity of the chemical compounds. A sensory array comprises a plurality of different sensory elements each dedicated to a certain chemical compound. Further, a sensory element may be dedicated to a certain class of chemical compounds, which contribute equal or similar to an odor sensation and may be measured by same sensory element due to similar or same interaction with the corresponding sensory element. Consequently, the number of measuring values may be given by the number of sensory elements, wherein the properties of the sensory elements define the chemical compounds which may be sensed and therefor also a kind of resolution or granularity of the sensory array for sensing odor, respectively.

A spectral analyzer operates on the basis of a spectral analysis of light-irradiated chemical compounds. Chemical compounds are irradiated by light and resulting characteristic spectral lines allow to indicate and identify the chemical compounds. The concentration of these chemical compound may be obtained from the spectral line width. Thus, the odor sensation is sensed by separating the odor into its several ingredients or chemical compounds, respectively. The spectral analyzer may offer the possibility to sense and identify a wide range of different chemical compounds and the number of chemical compounds which can be sensed and identified is only defined by the analysis of the gained characteristic spectrum. Chemical compounds of a class effecting a similar or equal odor sensation may be grouped together gaining a common measurement value.

In a sub-step S100.2, the sensed measurement values of the odor may be analyzed. The distinguishing between sensing and analyzing may be difficult and is dependent on the method for sensing odor. The analyzing may comprise a post-treatment of the sensed measurement values or a preparation for a following adaptation or coding of the odor information.

A post-treatment of the measurement data may comprise a selection of the measurement values. In case of a spectral analysis, sensed measurement values which do not contribute to the odor may have to be separated from sensed measurement values which relate to odor. Further sensed measurement values may be separated additionally into relevant and non relevant measurement values, wherein the relevance may be defined in accordance with the odor to be sensed. In comparison with the above described electronic nose a spectral analysis allows to sense more exactly the composition of an odor but the amount of resulting data may be enormous.

An analyzing process of special interest may be the obtainment of device independent odor information from the measurement. For this, the description of odor based on a pre-defined selection of odor aromas or categories, respectively, may be advantageous. The basic idea is that odor may be generated by mixing a selection of basic aromas which is e.g. comparable to the generation of different colors obtained by additive mixing red, green and blue light, normally used to generate color images on computer displays. The number of basic aromas is not limited. Since the mixing of aromas for generating odor is much more difficult than the additive color mixing, the higher the number of basic aromas for mixing the more similar the resulting generated odor sensation. The basic aromas may be termed in the following description as categories.

Preferably, the categories may be composed such that a large number of odor sensation is possible to be generated by for example mixing the categories in an adapted atomizer. Further preferably, the categories may be subjected to an odor subject such as nature, perfume or flowers. An odor subject may limit the number of odor sensations but may allow a more realistic generation of the respective odors.

Further, the coding of odor sensation based on categories may offer the possibility to provide a resulting odor information independent of the odor sensing unit and independent of the basic physical or chemical measuring method. Additionally, the selection of the categories may be especially chosen in order to provide an adequate based odor information which may be converted into device-dependent representations without too much differences in the resulting generated odor sensation.

Moreover, the analyzing and coding of an odor based on a plurality of categories may additionally offer the possibility to provide odor information of different complexity or resolution. According to the desired and/or required precision of the odor coding the number of the categories may be adapted. A relative low number of categories may offer a simplification of the real complex odor, wherein the low number of categories provide an easy to handle coding. With increasing number of categories the coding of the odor converge towards the real complex odor, but the increasing number of categories means that a handling of the odor coding, such as communicating or manipulating, increases in the difficulty, wherein the increase in view of the manipulating may be more than proportional.

In a sub-step S100.3, the coding of the odor information may comprise an adapting of the odor information. The adapting may be analog to the adapting described above with reference to step S120 illustrated FIG. 1 and FIG. 2 and further described below with reference to the sub-steps 5120.1, S120.2 and S120.3 illustrated FIG. 2. A detailed description may be looked up in the corresponding text passages.

The above described sub-steps S100.1, S100.2 and S100.3 maybe comprised by the operational step S100. This operational step results finally in providing an odor information. The odor information comprises data which allows to generate an odor by the means of an odor emitting device similar or equal to the sensed odor.

The following sub-steps S120.1, S120.2 and S120.3 describe possible operations which may be covered by an adapting operation of odor information shown in step S120 illustrated in FIG. 1 and FIG. 2. The adapting operations may not be limited or restricted to the following presented operations.

In a sub-step S120.1, the odor information may be limited. The limiting may relate to the strength of an total odor sensation or the strength of ingredients of the total odor sensation. According to the description above an odor normally comprises odors of a plurality of ingredients. Further, the strength of odor sensation differs upon humans. An individual adaptation of the strength is advantageous. Therefor, the limiting may offer the possibility to modify the strength coded in the odor information. Moreover, since the odor information codes a composition of different ingredients the limiting may be related to one or several selected ingredients.

A threshold value may define a maximal valid strength of an odor. In case that the total odor strength extends this threshold value the coded strength values may be reduced such that the threshold value is an upper limit of the odor strength. Similarly, a plurality of threshold values may define maximal valid strength of odor strengths coded within the odor information. A scaling value may limit the strength of an odor by scaling the total strength. Similarly, a plurality of,scaling values may limit distinct odor strengths coded within the odor information.

In a sub-step S120.2, the odor information may be replaced. The replacing may be employed to replace one or several ingredients coded within the odor information. The replacing may be based on a functional relationship linking the original odor information and the resulting modified odor information. The functional relationship may be pre-defined or may be defined by a user during the adapting operation. Moreover, the replacing may be operated in accordance to a certain replacing rule, which may be preferably stored in a database and retrieved therefrom for employing.

In a sub-step S120.3, the odor information maybe mapped. The mapping of the odor information may cover a wide range of different adapting objects. For example, the mapping operation may be employed to adapt an odor information to characteristics and/or properties of an odor emitting unit or device, respectively. The mapping may be based on a functional relationship linking the original odor information and the resulting modified odor information. The functional relationship may be pre-defined or may be defined by a user during the adapting operation. Moreover, the mapping may be operated in accordance to a certain mapping rule, which may be preferably stored in a database and retrieved therefrom for employing.

The respective adapting operation may be defined by corresponding adapting rules. These rules may be defined by a user or may be pre-defined. Rules defined by a user may allow a user to adapt the resulting generated odor to his personal preferences and wishes. More detailed description and examples of the adapting operation will follow below.

Pre-defined adapting rules may be employed to adapt an odor emitting unit or device to an odor sensing unit or device. For example, a coding of odor information of an odor sensing device may be based on a plurality of categories. The generation of an odor sensation may be based on a selection of odor aromas. But the categories and the odor aromas differ from each other. In such a case the odor information based on the plurality of categories may have to be mapped to the present odor aromas available for generating the odor sensation. The mapping may be performed in accordance with a corresponding mapping rule or adapting rule, respectively, which may be provided by the manufacturer of the odor emitting device or the supplier of the odor aromas to be used with the odor emitting device.

Additionally, the adapting rules may vary in time.

In a sub-step S140.1, the decoding of the odor information may comprise an adapting of the odor information. The adapting may be analog to the adapting described above with reference to step S120 illustrated in FIG. 1 and FIG. 2 and further described above with reference to the sub-steps S120.1, S120.2 and S120.3 illustrated FIG. 2. A detailed description may be looked up in the corresponding text passages.

In a sub-step S140.2, the odor emitting unit may generate an odor by mixing different basic aromas. The basic aromas may be physically mixed or may chemically react. The mixing is controlled by the odor information, preferably, weighting values or values of the amount may be comprised in order to control the mixing of the aromas. A detailed description of an odor emitting unit or device will follow below, respectively.

In a step S110 or in a step S130, the odor information my be communicated. The communication of the odor information may be employed if the sensing device and the generating device are single separated devices. The communication of the odor information maybe based on a wired or a wireless communication connection.

FIG. 3 shows two possible coding sequences of odor information with respect to the present invention. The illustrated coding may be advantageous for communicating odor information, particularly for communicating odor information via a wireless communication network.

A first coding sequence may describe the coding of an odor information comprising a set of categories according to the description of the categories above. The set of categories may be illustrated by a vector 100 comprising several vector elements. Each vector element may be assigned to a certain category and the value of each vector element may represent the amount of the basic aroma for mixing. Typically, the vector values may be quantized or normalized, respectively, i.e. the vector values vary in the range zero to one. More general, the odor information may be based on a time series of vectors 100, since the odor sensation may vary in time. FIG. 3 shows a sequence of three vectors 100 in order to illustrate such a time series.

The first coding sequence may also represent a coding of an odor information based on sensing odor active chemical compounds. Each vector value may be assigned to a certain chemical compound or a certain group of chemical compounds. Those skilled in the art will easily apply the following description of the first sequence on this sensing and coding method.

At a moment tₐ, a vector 100 may comprise a number of five different vector values 101 relating to five corresponding categories. The vector 100 may be comprised by the odor information. At this moment only the vector value s₄ may have assigned a non zero value, herein s₄=0.25. Accordingly, an odor emitting device may decode this vector and may be instructed to generate an odor related to the corresponding category 4 and related to the corresponding strength illustrated as vector value s₄.

After a certain period of time Tᵥ at a moment t_{b} a further vector 100 may be coded comprising again five different vector values 102. Now three different vector values may be non zero, vector value s₁ may have assigned s₁=0.5, vector value s₄ may have assigned s₄=0.25 and vector value s₅ may have assigned s₅=0.05. Accordingly, an odor emitting device may decode this vector and may be instructed to generate an odor related to the corresponding categories 1, 4 and 5 related to the corresponding strengths illustrated as vector values s₁, s₄ and s₅.

Again after a certain period of time Tᵥ at a moment t_{c} a further vector 100 may be coded comprising again five different vector values 103. Now two different vector values may be non zero vector value s₁ may have assigned s₁=0.5 and vector value s₅ may have assigned s₅=0.05. Accordingly, an odor emitting device may decode this vector and may be instructed to generate an odor related to the corresponding categories 1 and 5 related to the corresponding strengths illustrated as vector values s₁ and s₅.

The presented coding has the advantage that always a complete set of categories is transmitted within an odor information. In case of only a smaller number of coded categories the size of the corresponding odor information is neglectible. But with increasing level of detail the size of the odor information grows rapidly. Since odor sensation varies smoothly in time, a large number of redundant values may be transmitted. Especially, in case of coding odor information for transmitting via wireless communication networks, the size of the odor information may be expensive for a user transmitting this.

Therefor, a second coding sequence is presented. The second coding sequence is distinguished by avoiding redundant information. The coding sequence comprises a time series of the data packets each comprising a type information and an intensity or strength information, respectively. The intensity or strength may be quantized or normalized, respectively.

In the beginning of the second coding sequence an odor sensing device coding the sequence may not sense any odor, such that the corresponding odor information does not contain any relevant values.

At a moment t₁, an odor sensor 1 of an odor sensing device may sense an odor. A normalized strength of the odor may be coded as an intensity I₁=0.5. The designation of the sensor and the corresponding sensed intensity value may be coded within a data packet 200. Accordingly, an odor emitting device may decode data packet 200 and may be instructed to generate a corresponding odor. Further, the odor emitting device may be instructed to generate the corresponding odor until the odor sensing device reports a change in the measurement value of sensor 1. The moment t₁ is the onset of the sensing of sensor 1.

Up to a moment t₂, the odor sensing device may sense a constant measurement signal of odor sensor 1. And also the other available sensors may do not sense any changes. No further data packets are coded.

At a moment t₂, an odor sensor 4 of an odor sensing device may sense an odor. A normalized strength of the odor may be coded as an intensity I₄=0.25. The designation of the sensor and the corresponding sensed intensity value may be coded within a data packet 201. Accordingly, an odor emitting device may decode data packet 201 and may be instructed to generate a corresponding odor. The moment t₂ is the onset of the sensing of sensor 4. Further, the odor emitting device may be instructed to generate the corresponding odor until the odor sensing device reports a change in the measurement value of sensor 4. The generation of odor according to data packet 200 may be maintained.

At a moment t₃, an odor sensor 5 of an odor sensing device may sense an odor. A normalized strength of the odor may be coded as an intensity I₅=0.25. The designation of the sensor and the corresponding sensed intensity value may be coded within a data packet 202. Accordingly, an odor emitting device may decode data packet 202 and may be instructed to generate a corresponding odor. The moment t₃ is the onset of the sensing of sensor 5. Further, the odor emitting device may be instructed to generate the corresponding odor sensation until the odor sensing device reports a change in the measurement value of sensor 5. The generation of odor according to data packets 200 and 201 maybe maintained.

At a moment t₄, the odor sensor 4 of an odor sensing device may sense no more odor. Correspondingly, a data packet 203 may be coded comprising the designation of the sensor and an intensity value zero to indicate that the odor sensation according to sensor 4 may be stopped. The moment t₄ is the ending of the sensing of sensor 4. The generation of odor according to data packets 200 and 202 may be maintained.

At a moment t₄, the odor sensor 5 of an odor sensing device may sense a changed odor. A normalized strength of the odor may be coded as an intensity I₅=0.1. The designation of the sensor and the corresponding sensed intensity value may be coded within a data packet 204. Accordingly, an odor emitting device may decode data packet 204 and may be instructed to generate a corresponding odor sensation of changed intensity. The odor sensation according to data packet 200 may be maintained.

Between the moments t₁, t₂, t₃, t₄ and t₅ the odor sensing device may sense a constant measurement signals of the odor sensors such that no data packets are coded and the odor sensing device is instructed to maintain the generation of respective odor.

In order to illustrate the advantage of the second code sequence preventing redundant data the described sensor may be assigned to the categories described in combination with the first code sequence such that the coded odor information may be comparable on the time axis. The moment t₁ may shall take place before the moment tₐ, whereas the moments t₂ and t₃ shall take place between the moments tₐ and t_{b} and the moments t₄ and t₅ shall take place between the moments t_{b} and t_{c}. Both sequences effect the same odor generated by an odor emitting device. But the amount of data coded in the first sequence and handed over to the odor emitting device is larger than in the second sequence. On the other hand, the number of coded odor information packets is lower in the first sequence.

The coding in accordance with the second coding sequence may not only be advantageous with regard to preventing redundant information but also in view of the above mentioned spectral analysis. The spectral analysis such as a full spectroscopy may allow to approach a complete analysis of an odor based on all relevant ingredients. Such a complete analysis may be based on a complete determination of the molecular composition of the odor. The different odor active molecules being sensed may be far larger in their number than any coding based on aforementioned categories. The coding of an odor information may comprise the total spectral analysis. With reference to the first coding sequence, a vector value is assigned to each ingredients which may be sensed. Conveniently, the resulting vector may have an enormous number of elements and communication of such an odor information may be at least ineffective but may be also too time-intensive or just impossible. Moreover, such a vector may be populated sparsely and ineffective.

In the following text sections a possible mathematical representation of the adapting operation will be given. The mathematical representation may be described in combination with the coding of the odor information mentioned in connection with the first coding sequence described in FIG. 3. The mathematical representation of the odor information as a vector may be used. Again, the odor information may be coded on the basis of basic aromas or categories, respectively. The vector representation may be denoted as a vector a(t) comprising n vector elements according to a coding of the odor information based on n categories. The vector a(t) may be time-depending in accordance with the time-series aforementioned. The vector a(t) may be denoted as follows:

$$a ( t ) = ( \begin{matrix}{a}_{1} ( t ) \\ {a}_{2} ( t ) \\ ⋮ \\ {a}_{n} ( t )\end{matrix} )$$

wherein aᵢ(t)ε[0,1] ∀i due to the normalized aroma strengths of the single basic aromas or categories, respectively.

The adapting of the odor information comprising e.g. a scaling of the odor strength, a replacing of categories or a mapping of categories may be denoted mathematically as a matrix operation, representing a linear relationship of the original odor information denoted as vector a(t) and the adapted odor information denoted as vector a′(t). The following expressing may show a corresponding relationship:
a′(t)=M a(t)

The resulting adapted odor information vector a′(t) may comprise a number of m vector values aₗ′(t). These m vector values may be also related to a selection of m basic aromas or categories.

$${a}^{′} ( t ) = ( \begin{matrix}{a}_{1}^{′} ( t ) \\ {a}_{2}^{′} ( t ) \\ ⋮ \\ {a}_{m}^{′} ( t )\end{matrix} )$$

wherein aᵢ(t)ε[0,1] ∀i due to the normalized aroma strengths of the single basic aromas or categories, respectively.

In a first case the number of vector values aᵢ(t) and the number of vector values aᵢ′(t) may be equal, each odor information vectors a(t) and a′(t) may comprise n vector values aᵢ(t) or aᵢ′(t), respectively.

Different matrices M may be defined for adapting. In the following an exemplary selection of possible matrices may be presented.

### EXAMPLE

### Identity Matrix

$$M = ( \begin{matrix}1 & 0 & ⋯ & 0 \\ 0 & 1 & ⋯ & 0 \\ ⋮ & ⋮ & ⋰ & ⋮ \\ 0 & 0 & ⋯ & 1\end{matrix} )$$

The identity matrix converts the odor information vector a(t) into the adapted odor information vector a′(t) without any changes in the vector values. The resulting adapted odor information vector a′(t) is equal to the original odor information vector a(t).

### EXAMPLE

### Scaling Matrix

$$M = ( \begin{matrix}{m}_{1} & 0 & ⋯ & 0 \\ 0 & {m}_{2} & ⋯ & 0 \\ ⋮ & ⋮ & ⋰ & ⋮ \\ 0 & 0 & ⋯ & {m}_{n}\end{matrix} ) , with {m}_{i} ∈ [ 0 , 1 ] .$$

The main diagonal elements of the matrix may be set to values in the range of zero to one. The non main diagonal elements may be set to zero. From above defined relationship between odor information vector a(t) and adapted odor information vector a′(t) may follow, that each matrix element mᵢ is linked to the corresponding vector element aᵢ(t). Preferably, the vector elements of the resulting adapted odor information vector a′(t) may be expressed as aᵢ′(t)=mᵢ·aₗ(t) which represents a linear scaling of each vector element aᵢ(t).

Main diagonal elements may be set to zero in order to block completely certain vector elements. The Blocking of a vector element may result in a removing of basic aromas or categories from the odor information, respectively.

### EXAMPLE

### (n-n)-Mapping Matrix

$$M = ( \begin{matrix}{m}_{11} & {m}_{12} & ⋯ & {m}_{1 n} \\ {m}_{21} & {m}_{22} & ⋯ & {m}_{2 n} \\ ⋮ & ⋮ & ⋰ & ⋮ \\ {m}_{n 1} & {m}_{n 2} & ⋯ & {m}_{nn}\end{matrix} ) , with {m}_{i} ∈ [ 0 , 1 ] .$$

Substitution of basic aromas or categories by more favorable ones may be controlled by setting non main diagonal elements of the matrix M, respectively. A setting of the non main diagonal elements to non zero values may allow to linearly map a basic aroma to a linear combination of several basic aromas. Preferably, the matrix M is a square matrix M, such that the resulting adapted odor information vector a′(t) comprises the same number n of vector elements according to the original odor information vector a(t).

### EXAMPLE

### (n-m)-Mapping Matrix

$$M = ( \begin{matrix}{m}_{11} & {m}_{12} & ⋯ & {m}_{1 n} \\ {m}_{21} & {m}_{22} & ⋯ & {m}_{2 n} \\ ⋮ & ⋮ & ⋰ & ⋮ \\ {m}_{m 1} & {m}_{m 2} & ⋯ & {m}_{mn}\end{matrix} ) , with {m}_{i} ∈ [ 0 , 1 ] .$$

A more general definition of the mapping matrix M comprises a rectangular (m-n)-matrix M linking the original odor information vector a(t) comprising n vector elements aᵢ(t) to an adapted odor information vector a′(t) comprising m vector elements aᵢ′(t). Such a matrix definition may be employed to convert an odor information based on a selection of n basic aromas or categories to an odor information based on a selection of m different or partly different basic aromas or categories. For example, the conversion into an other combination of basic aromas may be performed in order to adapt odor information sensed by an odor sensing device to the properties of an odor emitting device based on emitting a mixture of aromas during the decoding of the odor information. The rectangular (m-n)-matrix M covers also the aforementioned examples.

The presented relationship for describing the adapting of an odor information bases on a linear linking of the odor information and the derived adapted odor information. Non linear relationships may also employed for linking. The presented matrix M also offers a simple and manageable representation of the adapting rules to a user, especially if the user may be allowed to define adapting rules according to his whishes and desires. The number of matrix values are assessable. It shall be noted, that the presented mathematical notation was only used to describe the adapting operation in an easy understandable manner and may not be limiting.

Principle, the adapting of odor information according to the aforementioned description may be preferably employed in case of odor information comprising a fixed and limited number of values as it is in case of odor information based on basic aromas or categories.

Additionally, the adapting operation comprise access to a database. The database may provide corresponding adapting rules. The database may provide adapting rules of the kind presented above in the representation of the matrix M. A providing of the adapting rules by a database may be preferable if the size of the rules is big, i.e. if the corresponding matrices M comprise a larger number of setted values.

The providing of adapting rules may be also advantageous in connection with a coding of the odor information in accordance with the second coding sequence illustrated in FIG. 3. The database may provide mapping rules to generate an odor by an: odor emitting device based on a plurality of basic aromas. Due to the fact, that the odor of a large number of different substances coded in the odor information may be simulated by mixing the basic aromas the trapping rules comprised in a database may be provided in combination with the respective set of basic aromas in order to obtain an adequate result. The aim of the mapping may be a closest as possible representation of the odor of the coded substances.

The adapting rules may vary in time.

The following FIG. 4 illustrates a timely sequence beginning with the sensing of an odor by an odor sensing device and finishing with the generating of an odor by an odor emitting device.

FIG. 4 illustrates a timely sequence of the odor information processing with respect to an embodiment the invention. The FIG. 4 illustrates an odor sensing unit 300, a processing unit 400 and an odor emitting unit 500. The processing unit 400 may be integrated in a device comprising the odor sensing unit 300 or the odor emitting unit 500. Further, the processing unit 400 may be also integrated in a separate device. Herein it may be assumed without limiting the scope of the invention that the odor sensing unit 300, the processing unit 400 and the odor emitting unit 500 may be integrated in different separate devices.

The following described operational steps are related to the operational steps described in detail with reference to FIG. 1 and FIG. 2. Additionally, the operational step of coding and a resulting timely sequence of odor information is described in detail with reference to FIG. 3.

At the beginning of the shown timely sequence in a step S200, an odor may be sensed by the odor sensing unit. The sensing of the odor may be obtained by employing one of the aforementioned odor sensing units or devices, respectively.

In a step S210 and S220, the measurement values according to the sensed odor may be analyzed and coded. The analyzing and coding may be performed with regard to a following communicating of the gained odor information.

In a step S225, the resulting odor information may be communicated to the processing unit 400. The communicating may be based on a wired connection or a wireless connection. Preferably, the wireless connection may be based on a wireless communication network such as a cellular mobile communication network. Therefore, the odor sensing unit 300 may be connected to a transmitter able to transmit via the corresponding used communication connection.

In a step 230, the odor information may be received by the processing unit 400 from the odor sensing unit 300. Therefore, the processing unit 400 may be connected to a receiver able to receive the communicated odor information. The odor information may be adapted in accordance with an adequate adapting rule.

In a step S235, the resulting adapted odor information may be communicated to the odor emitting unit 500. Analogously, the communicating may be based on a wired connection or a wireless connection. Preferably, the wireless connection may be based on a wireless communication network such as a cellular mobile communication network. Therefore, the processing unit 400 may be connected to a transmitter able to transmit via the corresponding used communication connection.

In a step S240, the odor information may be received by the odor emitting unit 500 from the processing unit 400. Therefore, the odor emitting unit 500 may be connected to a receiver able to receive the communicated odor information. The odor information may be decoded in order to be applied for the following odor generation.

In a step S250, an odor may be generated based on the decoded odor information. Preferably, the generated odor may be as similar as possible to the odor sensed. Usually, an odor may be generated by emitting a mixture of different aromas.

Additionally, the operational step S220 of coding may comprise an adapting operation. The adapting operation may be advantageous for obtaining device independent odor information. A suitable method for obtaining this device independent odor information may be an adapting and coding of the sensed odor based on a plurality of basic aromas. The number of basic aromas may Further additionally, the operational step S240 of decoding may comprise an adapting operation.

The adapting operation may be advantageous for adapting the odor information coded according to the properties and characteristics of the odor sensing unit or device to the properties and characteristics of the odor emitting unit or device

Further additionally, the operational steps S230, S220 and/or S240 may comprise an accessing of a database for obtaining information due to the coding, decoding and/or adapting.

FIG. 5 illustrates an arrangement of communicating mobile devices according an embodiment of the system of the present invention. The FIG. 5 illustrates a first mobile device 600 connected to an odor sensing unit 610 and a second mobile device 700 connected to an odor emitting device 710.

The first mobile device 600 connected to the odor sensing unit 610 may be employed for sensing, analyzing and coding an odor for a following transmission of the resulting odor information.

The odor sensing unit 610 may be based on different methods for sensing an odor. A first preferable method for sensing odor may be a sensory analysis. The sensory analysis employs e number of sensors which are primarily specialized and detected in sensing substances or a class of substances. Each sensor may be designed for sensing an intensity of one substance or one class of substances, respectively. Consequently, the more sensors are involved in sensing the more representative in the measurement result, since it includes more odor relevant substances. A second preferable method for sensing odor may be a spectral analysis. The spectral analysis allows to sense a large number of substances by, the means of evaluating spectrums by illuminating with light of certain wavelengths. The sensed odor is separated into its ingredients by using for example a real-time spectral analyzer.

The sensing unit 610 may be designed as a mobile analysis module. The mobile analysis module may be small enough to be built in a mobile device, e.g. a mobile phone or a palm sized personal digital assistant. The analysis of odor may be possible at any time and at any place. Odor may be analyzed by holding a device integrating the mobile analysis module close to the odor source. The analyzing process may be initiated by a user input, e.g. pressing a certain starting button. If the analysis is finished the resulting odor representation may be stored and/or may be transmitted to another device, e.g. a device able to generate an odor in accordance with the odor representation. Depending on the application, a continuous analysis of odor, e.g. of the environment's odor, may take place in intervals. Further, the sensing unit 610 may be designed as a desktop analysis module. The desktop analysis module may be small enough to be used on a desktop in combination with a personal computer or another adequate processing device. An odor source may have to be fixed on an object slide. This object slide may be given to the analysis equipment that is built into a box. This box may be prepared with an object slide mounting that is close to the analysis device. After the object slide may be fixed, the analysis process can be started. The complete process may be controlled by the personal computer that is connected to the desktop analysis module. If the analysis is finished, the resulting odor representation can be shown on the computer's display and can be stored to disk. The computed odor representation can easily be transferred to a mobile device, e.g. via SMS or transfer cable.

Both the mobile analysis module and desktop analysis module, which may either use the sensory or spectral analysis, compute an odor representation. Preferably, the computed odor representation may be based on the ideas of the coding that are presented and described above. Conveniently, processing capability for analyzing and coding the representation of the odor may be provided. The processing capability may be provided by an adequate processing unit or processing means, respectively, which may be integrated in the respective analysis module or which may be connected to the analysis module. For example, difficult and time-consuming processing operations may be operated on an external processing device or means. Such a processing device may be connected to the analysis module via a communication network.

Additionally, the mobile device 600 comprising the odor emitting unit 610 may comprise at least a receiver and more generally a transceiver. The receiver may be employed to receive the odor information. The receiver or transceiver may be connected to a communication network, respectively. The communication network may be based on wired connection or on wireless connection. A typical wired connection may be a local area network (LAN), a wide area network (WAN) or a connection such as a dedicated telephone line. A typical wireless connection may be a cellular communication network e.g. based on the GSM (global system for mobile communication) standard, the UMTS (universal mobile communication standard) standard or similar. Further a wireless communication network may be a Bluetooth network, a wireless local area network (WLAN) or an infrared communication network. According to the illustration shown in FIG. 5, the communication capability may be provided by the mobile device 600.

The second mobile device 700 connected to the odor emitting unit 710 may be employed for decoding and generating an odor in accordance with the odor information received.

The odor emitting unit 710 may be based on an aroma mixing and exposing mechanism. A number of aromas for example filled in separate flasks and a mounting device carrying the flasks may be provided. Preferably, the flasks may be detachable in order to vary the composition or in order to exchange flasks if the aromas are used up. In order to provide the possibility to generate several different odors a defined number of different basic aromas may be mounted. A release mechanism may provide for the mixing and the exposing of the aromas. The specific amount of the aromas may be obtained from the odor information. Preferably, the aromas may be sprayed into a antechamber, collected and mixed therein before exposing to the outside of the odor emitting unit 710. The controlling of the complete operation of the odor emitting unit 710 may be based on the odor information. Advantageously, it may be inevitable to define several base aromas that do not have to vary between the different devices. This may allow checking the synthetic odor in advance to receive best results

The odor emitting unit 710 comprising such an aroma mixing and exposing mechanism may be integrated into different devices. For example, the odor emitting unit 710 may be integrated into a mobile device. As separate accessory for mobile devices particularly mobile phones the user may attach a new battery pack to his mobile device. Included here may some flasks carrying base aromas. The number of base aromas may vary. An equivalent implementation may be obtained by including the flasks with the basic aromas into the cover of the mobile device. Preferably, to enable the usage in mobile phones the mounting mechanism shall be shock proof to avoid any damage to the flasks.

Further, an odor emitting unit 710 may be integrated in or connected to fixed set up devices. For example, it may be possible to integrate an odor emitting unit 710 into an device for spreading odor within rooms or within complete houses. These devices may be controlled remotely by transmission of odor information in accordance with the odor to be spread. A user may decide and activate such a device by employing his mobile phone able to transmit odor information before arriving at home.

Conveniently, processing capability for decoding the representation of the odor may be provided. The processing capability may be provided by an adequate processing unit or processing device, respectively, which may be integrated in the respective odor emitting unit 710 or which may be connected to the odor emitting unit 710. For example, difficult and time-consuming processing operations may be operated on an external processing device. Such a processing device may be connected to the analysis module via a communication network.

Additionally, the mobile device 700 comprising the odor emitting unit 710 may comprise at least a receiver and more generally a transceiver. The receiver may be employed to receive the odor information. The receiver or transceiver may be connected to a communication network, respectively. The communication network may be based on wired connection or on wireless connection. A typical wired connection may be a local area network (LAN), a wide area network (WAN) or a connection such as a dedicated telephone line. A typical wireless connection may be a cellular communication network e.g. based on the GSM (global system for mobile communication) standard, the UMTS (universal mobile communication standard) standard or similar. Further a wireless communication network may be a Bluetooth network, a wireless local area network (WLAN) or an infrared communication network. According to the illustration shown in FIG. 5, the communication capability may be provided by the mobile device 700.

The illustrated mobile device 600 comprising the odor sensing unit 610 and mobile device 700 comprising the odor emitting unit 710 provide different functionality related to the different comprised units. It shall be noted that both the mobile device 600 or the mobile device 700 may comprise an odor sensing unit 610 as well as an odor emitting unit 710 such that both the mobile device 600 or the mobile device 700 provide the capability to sense and to generate odor.

According to FIG. 5, the odor 810 of a flower 800 may be sensed by the mobile device 600 and subsequently generated by mobile device 700. The odor sensing unit 610 of the mobile device 600 may be employed to sense the odor 810 of the flower 800. In accordance with the above presented description, the odor may be sensed and analyzed and a corresponding odor information may be coded. The necessary processing operations may be performed by the odor sensing unit 610 or may be also performed by the mobile device 600. The odor information may offer a valid representation based on electronic data The odor information transmitted to the mobile device 700 or the odor information may be stored and forwarded later to the mobile device 700. Preferably, the odor information may be transmitted via a mobile communication network 650. The mobile device 700 may receive the odor information. The odor information may be decoded and finally the odor emitting unit 710 may generate an odor 820 in accordance with the received odor information. The necessary processing operations may be performed by the odor emitting unit 710 or may be also performed by the mobile device 700.

The sensing, analyzing and/or coding operation performed by the mobile device 600 and/or the odor sensing unit 610 may comprise access to a further processing means 900. The processing means may offer processing capabilities or may offer database access. The access to the processing means 900 may be established via a mobile communication network 651, a receiver 910 and a connecting communication network 905. The access to the processing means 900 may allow to transfer operational steps to the processing means 900 or may offer the possibility to access data necessary for the sensing, analyzing and/or coding.

The decoding and/or generating operation performed by the mobile device 700 and/or the odor emitting unit 710 may comprise access to a further processing means 900. The processing means may offer processing capabilities or may offer database access. The access to the processing means 900 may be established via a mobile communication network 652, a receiver 910 and a connecting communication network 905. The access to the processing means 900 may allow to transfer operational steps to the processing means 900 or may offer the possibility to access data necessary for the decoding and/or generating.

An adapting of the odor information may be operated and performed by either the mobile device 600 or the mobile device 700. For example, a user receiving an odor information may ensure that the strength of the generated odor is not too strong. The user may be allowed to define a corresponding limiting rule or scaling rule on the mobile device 700 for adapting the odor information. Moreover, a user operating the mobile device 600 and controlling the odor sensing may ensure that the strength of the sensed odor is lowered. Accordingly, the user may be allowed to define a corresponding limiting rule or scaling rule on the mobile device 600 for adapting the odor information.

Further, the processing means 900 may be interposed in a transmission of the odor information between the transmitting mobile device 600 and the receiving mobile device 700, wherein the processing means 900 can be integrated in some transmission means, processing means or other communication means. The interposed processing means 900 may comprise adapting rules for example to protect the receiver of the odor information of bad odors or to strong odors. The interposed processing means 900 may also comprise adapting rules to adapt the odor information sensed by the certain odor sensing unit 610 to the characteristics and the properties of the odor emitting unit 710.

This specification contains the description of implementations and embodiments of the present invention with the help of examples. It will be appreciated by a person skilled in the art, that the present invention is not restricted to details of the embodiments presented above, and that the invention can be also implemented in another form without deviating from the characteristics of the invention. The embodiment presented above should be considered as illustrative, but not restricting. Thus, the possibilities of implementing and using the invention are only restricted to the enclosed claims. Consequently, various options of implementing the invention as determined by the claims, including equivalent implementations, also belong to the scope of the invention.

1. A method for processing odor information, comprising the steps of:
coding odor information, said odor information comprising at least an odor type and a corresponding odor strength,
processing said coded odor information by mapping parts of said coded odor information in accordance with a predefined processing rule for converting said coding, and
decoding said processed odor information.

2. The method according to claim 1, wherein said processing of said coded odor information further comprises the step of:
modifying said odor information in accordance with at least one threshold value.

3. The method according to claim 1, wherein said processing of said coded odor information further comprises the step of:
scaling said odor information.

4. The method according to claim 1, wherein said processing of said coded odor information further comprises the step of:
replacing parts of said odor information in accordance with a predefined replacing rule.

5. The method according to claim 1, wherein said coding further comprises the step of:
sensing said odor information by means of an odor sensing device.

6. The method according to claim 5, wherein said sensing further comprises the step of:
analyzing said odor information in order to obtain an odor information based on a plurality of basic odor aroma; and
coding odor information based on said plurality of basic odor aroma.

7. The method according to claim 5, wherein said sensing further comprises the step of:
analyzing said odor information based on a complete analysis comprising relevant ingredients; and
coding subsequently odor information based on said relevant ingredients.

8. The method according to claim 1, further comprising the step of:
receiving odor information from said odor sensing device

9. The method according to claim 8, wherein said odor information is received via a wireless communication network.

10. The method according to claim 1, further comprising the step of:
storing said odor information.

11. The method according to claim 1, further comprising the step of:
transmitting said odor information to an odor emitting device.

12. The method according to claim 11, wherein said odor information is transmitted via a wireless communication network.

13. The method according to claim 1, further comprising the step of:
generating odor by means of said odor emitting device.

14. The method according to claim 13, wherein said generating of said odor information further comprises the step of:
mapping parts of said odor information in accordance with a predefined mapping rule.

15. A software tool for adapting odor information, comprising program code portions for carrying out the operations of claim 1 when said program is implemented in a computer program.

16. A computer program for adapting odor information, comprising program code portions for carrying out the operations of claim 1 when said program is executed on a computer, a processing device or a mobile terminal.

17. A computer program product for adapting odor information, comprising program code portions stored on a computer readable medium for carrying out the operations of claim 1 when said program product is executed on a computer, a processing device or a mobile terminal.

18. A mobile device for sensing, coding and communicating odor, comprising:
an odor sensing unit for sensing odor and obtaining odor information;
an odor coding unit for coding said odor information being sensed and obtained;
processing means for processing said coded odor information by mapping parts of said coded odor information in accordance with a predefined processing rule for converting said coding, and
a transmitter for communicating said processed odor information.

19. A mobile device for receiving, decoding and generating odor, comprising:
a receiver for receiving coded odor information;
processing means for processing said coded odor information by mapping parts of said coded odor information in accordance with a predefined processing rule for converting said coding,
an odor decoding unit for decoding said processed odor information; and
an odor emitting unit for generating an odor on the basis of said decoded odor information.

20. A system for communicating odor, said system comprising:
a device for sensing, coding and communicating odor including;
an odor sensing unit for sensing odor and obtaining odor information;
an odor coding unit for coding said odor information being sensed and obtained; and
a transmitter for communicating said coded odor information,
processing means for processing said coded odor information by mapping parts of said coded odor information in accordance with a predefined processing rule for converting said coding,
means for transmitting said processed odor information; and
a device for receiving, decoding and generating said processed odor including:
a receiver for receiving said processed odor information;
an odor decoding unit for decoding said received odor information; and
an odor emitting unit for generating an odor on the basis of said decoded odor information.
